(19) United States
(12) Patent Application Publication
(10) Pub. No.: US 2014/0081758 A1
(43) Pub. Date: Mar. 20, 2014

(54) METHOD AND APPARATUS FOR ADVERTISEMENT DISTRIBUTION

(71) Applicant: Artihove Regina B.V., (US)

(72) Inventor: Jelle Herman VAN DIJK, Bergschenhoek (NL)

(73) Assignee: ARTIHOVE REGINA B.V., Bergschenhoek (NL)

(21) Appl. No.: 13/780,351

(22) Filed: Feb. 28, 2013

(30) Foreign Application Priority Data
Feb. 29, 2012 (EP) 12157465.1

(51) Int. Cl. G06Q 30/02

(52) U.S. Cl. CPC G06Q 30/0251
USPC 705/14.55; 705/14.4; 705/14.66

(57) ABSTRACT

A method 400 for selecting and displaying on an electronic device categorized advertisements, the categorization being hierarchical and comprising a first category and a set of second categories contained in the first category, each advertisement of a set of advertisements classified in the first category is also classified in one of the second categories. Optionally, the method comprises matching 420 advertisements of the set of advertisements with a user profile to determine a fitness. The method further comprises
selecting 430 from the set of advertisements classified in the first category the advertisements, possibly those having a high fitness, to obtain a first group 210 of general advertisements,
selecting 440 from the advertisement being classified in a specific one of the second categories the advertisements, possibly those having a high fitness, to obtain a second group of specific advertisements, and
displaying 450 simultaneously at least part of the first group of general advertisements and at least part of the second group of specific advertisements.

### FIELD OF THE INVENTION

The invention relates to a method for selecting and displaying on an electronic device categorized advertisements, the categorization being hierarchical and comprising a first category and a set of second categories contained in the first category, each advertisement of a set of advertisements classified in the first category is also classified in one of the second categories.

### BACKGROUND OF THE INVENTION

For internet businesses the distribution of advertisements is becoming increasingly important; often advertisements drive an important part of the businesses.

It is known that an advertisement is more effective if the advertisement happens to address a need the user currently has. An advertisement for a garden chair is likely to be appreciated much more by a user who is currently looking for a new garden chair.

One way this insight has been implemented in current electronic equipment, is to add a hierarchical classification system to, say, an online catalog. By selecting ever more specific sub-categories, the user is guided to advertisements in the catalog specific to his need. For the example, above, the user might need to select ‘garden’, ‘garden furniture’, and ‘garden chairs’. Finally, the user is presented with advertisements from the ‘garden chairs’ category. Unfortunately, it takes multiple actions from the user to arrive at advertisement content.

Another way, advertisement effectiveness for electronic device has increased, is by profiling. Multiple advertisement profiles are matched to a user profile to select from the multiple advertisements the most appropriate ones. Although this system may avoid, say, displaying diaper advertisements to a user without infants, such a system would not be specific enough to show garden chairs, since such specific information is only current for a short time and would therefore not be present in a profile.

### SUMMARY OF THE INVENTION

It is a problem of the prior art to display both relevant advertisement content quickly yet at the same time allow a user to specifically select advertisement in a specific category.

It is advantageous to use a categorization which is hierarchical and comprises a first category and a set of second categories contained in the first category. Each advertisement of a set of advertisements classified in the first category is also classified in one of the second categories.

A method comprises selecting from the set of advertisements classified in the first category a first group of general advertisements, selecting from the advertisement being classified in a specific one of the second categories a second group of specific advertisements, and displaying simultaneously at least part of the first group of general advertisements and at least part of the second group of specific advertisements.

The user is presented a first group of general advertisements, which are selected from a large pool of general advertisements representing a first category and a second group of specific advertisements selected form a sub category of the first category. Thus the user is quickly presented with advertisements which he may immediately select, yet he also has the option to progressively select sub categories until he arrives at specific advertisement according to his need. On the average users need to give less input to arrive at relevant advertisement, e.g., sale offers and the like.

Advertisements may be embodied in a variety of ways. For example, a web shop item is an example of an advertisement. Advertisements may comprise any one of a picture, a text item, a price, a film clip, etc.

An advantageous embodiment of the method for selecting and displaying categorized advertisements implemented on an electronic device is provided. The categorization, i.e., the classification system, is hierarchical and comprises a first category and a set of second categories contained in the first category. Each advertisement of a set of advertisements classified in the first category is also classified in one of the second categories. The method comprising matching advertisements of the set of advertisements with a user profile to determine a fitness, selecting from the set of advertisements classified in the first category the advertisements having a high fitness to obtain a first group of general advertisements, selecting from the advertisement being classified in a specific one of the second categories the advertisements having a high fitness to obtain a second group of specific advertisements, and displaying simultaneously at least part of the first group of general advertisements and at least part of the second group of specific advertisements.

The method displays the first and second categories, thus informing the user about the categorization used, but at the same time advertisements are shown relevant to that category. Thus the time before relevant advertisements are displayed to the user is reduced compared to other menu systems that display advertisements after an end-category has been reached. On the other hand, the user is shown advertisements matched to his profile, but is still capable to selectively restrict the shown advertisement to a currently important category. Using the method, information is carried to the user in a more effective way, likely reducing the time until a relevant advertisement is shown.

The electronic device may be a mobile phone, a table, a laptop, a computer, etc.

The advertisements typically comprise an image, and a price offer. Preferably, the first category contains two different second categories, which are both non-empty. The categorization being hierarchical and has a root category. Preferably, any non-root category has a parent category, and every non-end category contains at least one, but preferably two sub-categories. An advertisement classified in a particular category is also classified for the parent category, and any of it grandparents. In an embodiment, the first category is the root category of the classification, so that all advertisements are classified as the first category.

To match advertisements of the set of advertisements with a user profile to determine a fitness, for example, each advertisement may be associated with an advertisement profile; the matching may then comprise matching an advertisement profile with a user profile. For example matching two profiles may comprise computing a dot product of a vector in the advertisement profile indicating desired features with a vector in the user profile indicating the presence/absence of said features. Preferably, the fit between a user and an advertisement is represented as a value.

Selecting advertisements having a high fitness in both a parent category, i.e., the first category, and in a specific sub-category thereof, i.e., the second category has the advantage of simultaneously informing about possibly relevant subcategories and at the same time presenting advertisements which are specific for that user.

A high fitness may be determined in various ways. For example, only advertisement may be selected having fitness above a threshold. The threshold may be pre-determined or dynamic. The threshold may be a global threshold or specific, e.g., specific to a category. Instead of a threshold the advertisements may be sorted for fitness, and the top part of the sorted advertisements may be selected. For example, a certain percentage may be selected, or a certain number of advertisements.

Preferably, for more, or even each, further one of the second categories a further second group of specific advertisements is obtained. For example, by selecting from the advertisement being classified in the further one of the second categories the advertisements having a high fitness.

Preferably, the advertisements selected in the parent category, i.e., the first category, and the advertisements selected in one or more second categories are displayed together as much as possible; at least part of the first group and a second group are visible together. Preferably, also an indication is shown for each group indicating to which category selected advertisements belong.

An advertisement selected for the first category will also be selected for one of the second categories contained in it. For convenience the method may show such an advertisement twice. However, the method may also decide suppress show that same advertisement twice, or to show it in a different format the second time, e.g. smaller.

The screen on which the advertisements are to be displayed may be too small to accommodate all of the information. Preferably, the display is configured such at least part of the selected first category advertisements are visible and at least part of one selected second category advertisements is simultaneously visible. Other advertisements in the same group, or other categories may be made visible on the display by scrolling, e.g., using cursor keys or swiping the screen. For example, horizontal scrolling may show additional advertisement, and vertical scrolling additional second categories.

Preferably, all of the displayed categories are individually scrollable. If a user is interested in seeing more advertisements in a particular category he need not scroll the entirety of the screen only the one category.

One way of displaying advertisements on a screen is to present the advertisements in the same group, in a row aligned with a side of the screen. This allows individual scrolling.

In an embodiment, a user choice for a chosen second category may be received. This gives new information; apparently, the user is not currently interested in most of the shown advertisements. In a way the method is then applied on a lower level, the chosen second category taking the place of the original first category and the third categories contained in the chosen second category taking the place of the original second categories.

Specifically, upon receiving the input, the displaying of the first group of general advertisements is stopped as well as the displaying of any second group of advertisements and further second group for a non-chosen one of the second categories.

From the advertisements classified in a specific one of the third categories, those advertisements are selected that have a high fitness to obtain a third group of specific advertisements. Preferably, this is done for more, or even all, third categories contained in the chosen second category.

Selecting from the advertisement classified in the chosen second category, those advertisements that have a high fitness is already done before receiving the user choice. Next, at least part of the second group of specific advertisements corresponding to the chosen second category and at least part of the third group of specific advertisements are displayed simultaneously.

A further aspect of the invention concerns an electronic device for selecting and displaying categorized advertisements, comprises a memory configured to store a categorization, the categorization being hierarchical and comprising a first category and a set of second categories contained in the first category, a receiver for receiving a set of advertisements, each advertisement of the set of advertisements classified in the first category is also classified in one of the second categories, and each advertisement having a fitness, a selector configured to select from the set of advertisements classified in the first category the advertisements having a high fitness to obtain a first group of general advertisements, and select from the advertisement being classified in a specific one of the second categories the advertisements having a high fitness to obtain a second group of specific advertisements, and a display configured to display simultaneously at least part of the first group of general advertisements and at least part of the second group of specific advertisements.

A matching module configured to match advertisements of the set of advertisements with a user profile to determine a fitness may be included in the electronic device. Alternatively, such matching may be done elsewhere, in larger system for distributing advertisements.

The electronic device may be a mobile electronic device such as a mobile phone; the electronic device may be a set-top box, computer, etc.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer

In a preferred embodiment, the computer program comprises computer program code means adapted to perform all the steps of a method according to the invention when the computer program is run on a computer. Preferably, the computer program is embodied on a computer readable medium.

The invention advantageously provides a method for selecting and displaying on an electronic device categorized advertisements, the categorization being hierarchical and comprising a first category and a set of second categories contained in the first category, each advertisement of a set of advertisements classified in the first category is also classified in one of the second categories. Optionally, the method comprises matching advertisements of the set of advertisements with a user profile to determine a fitness. The method further comprises selecting from the set of advertisements classified in the first category the advertisements, possibly those having a high fitness, to obtain a first group of general advertisements, selecting from the advertisement being classified in a specific one of the second categories the advertisements, possibly those having a high fitness, to obtain a second group of specific advertisements, and displaying simultaneously at least part of the first group of general advertisements and at least part of the second group of specific advertisements.

### BRIEF DESCRIPTION OF THE DRAWINGS

The invention is explained in further detail by way of example and with reference to the accompanying drawings, wherein:

FIG. 1 is a tree diagram illustrating a classification system,

FIG. 2 is a schematic diagram illustrating a data display,

FIG. 3 is a schematic diagram illustrating the data display after selection of category 11,

FIG. 4 is a flow chart illustration an advertisement selection method,

FIG. 5 is a screenshot of a mobile phone,

FIG. 6a is schematic diagram illustrating a first advertisement distribution system,

FIG. 6b is schematic diagram illustrating a second advertisement distribution system.

FIG. 7 is schematic block diagram illustrating matching

Throughout the Figures, similar or corresponding features are indicated by same reference numerals.

### LIST OF REFERENCE NUMERALS

100 a classification system
1 a root category
11, 12, 13 first categories
111, 112,113,121,122 second categories
1111, 1112 third categories
110 categories contained in category 11
120 categories contained in category 111
200 a first display
210 a row with advertisement of a first category
220, 230, 240 a row with advertisements in second categories
252, 254 scrolling directions
260 a visible area
300 a second display
310, 320, 330 a row with advertisements in third categories
400 a flowchart for displaying advertisements
500 a screenshot of a mobile phone display
602 a first advertisement display system
604 a second advertisement display system
610 an advertisement database
612 an advertisement profile database
614 an advertisement content database
620 an advertisement record
622 a classification
624 an advertisement profile
626 advertisement content
628 other data
630 a user profile database
635 a user profile
640 a matcher
650 a mobile phone
652 a selector
654 a user input device
656 a display
658 a receiver
700 a matcher
710 a filter
722 a matching coefficient module
724 a behavioral module
726 a target group size module
728 a time module
730 an integrator
740 a selector

### DETAILED EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

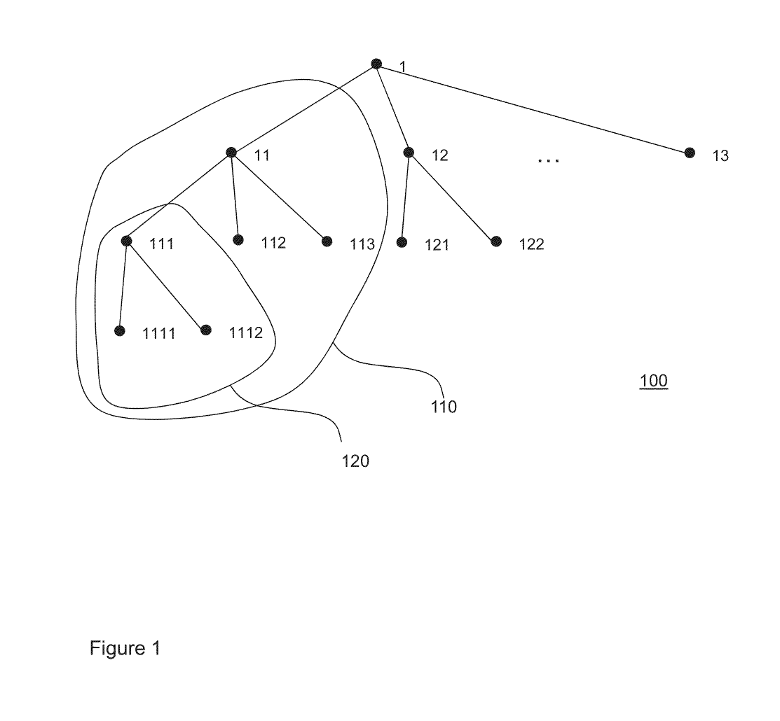

FIG. 1 shows a hierarchical classification system 100, i.e. a categorization having a tree form. Classification system 100 comprises a root category 1. Any advertisement used in the system is classified in root category 1. Such a category may be represented as ‘General’. Below the root category, are second categories. Shown are three second categories, 11, 12, and 13, each of which is contained in root category 1. Some of the second categories itself have sub-categories. For example, category 11 contains third categories 111, 112 and 113; category 12 contains third categories 121 and 122. Finally, for the figure shows that sub-category 111 is further divided into categories 1111 and 1112.

As an example only, category 11 may be ‘furniture’, 12 may be books, 13 may be Travel. Category 111 may be garden, 112 may be living room, and 113 may be bedroom. Category 1111 may be garden chairs, 1112 may be garden tables.

When selecting advertisements for fitness in category 11, all of the categories indicated by 110 are taken into account. When selecting advertisements for fitness in category 111, all of the categories indicated by 120 are taken into account. This may be achieved by only classifying advertisements in end-categories.

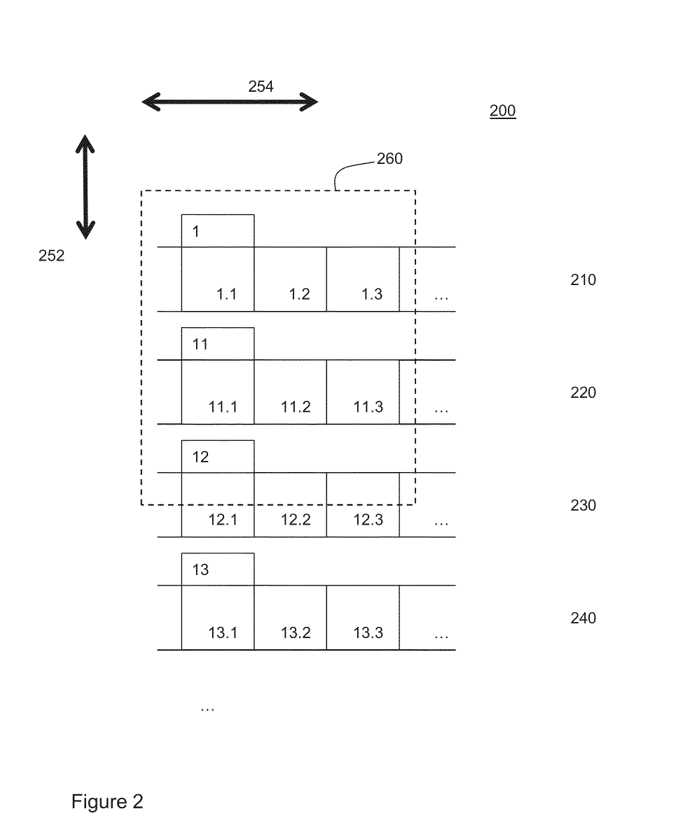

FIG. 2 shows in schematic form a display 200, which is one way of displaying information, i.e., advertisements, such that both purposive selection and quick display of targeted advertisement is possible.

FIG. 2 shows 4 rows: 210, 220, 230, 240. Each row shows a number of advertisements, one after the other. Row 210 is a general row, it shows advertisement selected from a first category. Rows 220-240 are specific to a category contained in the first category. Directly above each row an indication of the category is given. Referring to FIG. 1, row 210 corresponds to category 1, and rows 220-240 correspond to its sub-categories: 11, 12, and 13. The advertisements themselves are represented as numbered squares. The number before the dot indicating the category, the number after the dot is a serial number. In an implementation one would preferably use words for the category titles. The advertisements would typically comprise a picture.

Not all of the selected advertisements are visible at the same time. A visible area is indicated with reference number 260. What is visible can be changed by using sliders 252 and 254. It is possible to slide the entire area 260 across the multiple parallel rows representing advertisements. However more preferable, the slider 252, works globally, i.e., scrolls across the multiple categories, i.e., by moving area 260 down and/or upwards. Yet, slider 254 works preferably on a per row basis; for example, a user may swipe the screen along a row, to slide the row. In this way a minimal part of the display is changed, thus the amount of new information presented to the user is minimized to only that additional information in which he is interested.

Advertisements in row 210 where selected as high fitness advertisements across the general set of all advertisements in the first category, say category 1. Advertisements in rows 220-240 where selected as high fitness advertisements across the specific set of advertisements in a specific second category contained in the first category, say categories 11, 12, and 13. Thus advertisements in the rows 220-240 are at the same time targeted to a user profile yet are also specific for a current need of the user.

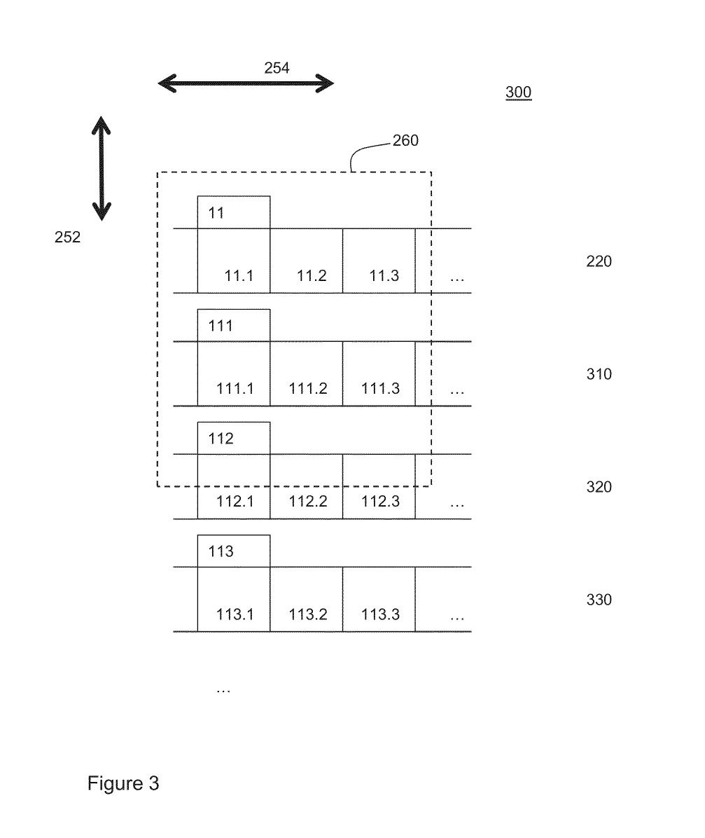

The electronic device whose display is configured for displaying a display, e.g. such as display 200, preferably also has an input device for selecting a category. For example, the category names may be selected, e.g. ‘tapped’. Upon selecting category 11, a new display is created, which is shown in FIG. 3.

FIG. 2 shows advertisements in the same category grouped together in rows. This in advantageous placement since it allows per-category scrolling. The rows are preferred to run in the reading-direction, i.e., horizontal with respect to a user, however vertical placement is also possible. Other ways of placing advertisements in groupings together are also conceivable, say in clusters together.

FIG. 3 shows a second schematic display. After category 11 has been selected, the general row 210, and rows 230, 240 corresponding to non-selected second categories 12 and 13 are removed. Row 210 is promoted to the general row. New rows are now constructed for each specific to each sub-categories of category 11. The latter are shown as rows 310, 320 and 330.

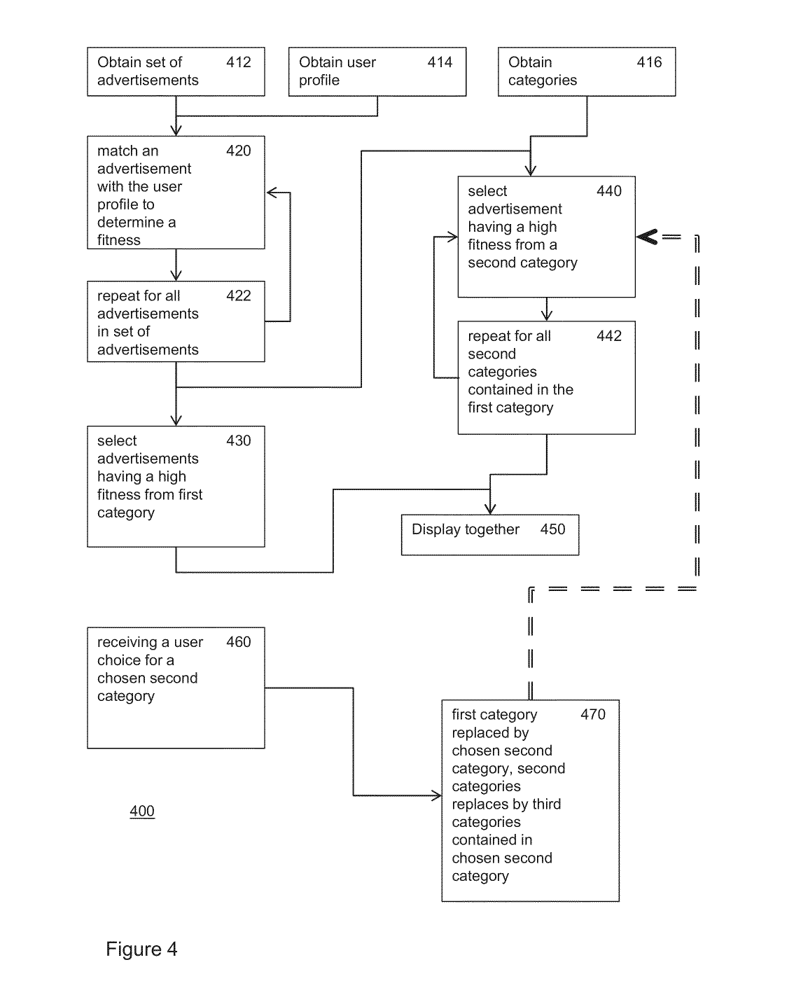

FIG. 4 shows a flow chart 400. The flowchart of FIG. 4 may be implemented on the electronic device, say mobile phone or table. However, parts of the method may be executed in a larger system, e.g. steps 414, 420, 422, 430, 440 442, 416 could be executed on a server, which send the results to the electronic device.

First a set of advertisement is obtained 412, also a user profile is obtained 414. Using techniques, known per se, a fit is determined between the advertisement and the user profile. For example, an advertisement may be associated with an advertisements profile which is matched to a user profile. For example, the advertisements profile may indicate a target income of above average for an expensive jewelry item. If the user profile contains an income of above average, than this feature would contribute to a high fit. As a further example, the advertisements profile may also indicate a married status; if the user profile indicates married this also contributes to a high fit.

Such a fitness would be determined for all advertisements 422. Next advertisements with a high fit may be selected. For example, a number, say 100, of the highest scoring advertisements may be selected. These may be displayed in a row, say row 210. Since this selection runs over all sub-categories of the first category this selection is expected to be very varied. These advertisements, having high fitness across all categories, are referred to as the first groups.

Also categories are obtained 416. The advertisements are classified. For each 442 category contained in the first category, i.e. the ‘second categories’, the highest scoring advertisements are selected. Again ‘high’ may be implemented in a suitable manner, such as: being higher than a threshold, the highest number or percentage etc. For each second category a second group is determined.

Finally, at least part of the advertisements in the first group and at least part of at least one second group is displayed 450.

At this point the user has several options to interact with the system, including:
scrolling in a first direction 252 to see more categories,
scrolling a row in a second direction to see more advertisement of that particular category,
selecting an advertisement to, e.g., view that advertisement or to buy a product,
choosing a second category.

Once a user choice for a chosen second category is received 460, the method is repeated but at a different letter. The chosen second category is now shown as the general category and steps 440, 442 are repeated for the sub-categories of the chosen category.

So, if the fitness of an advertisement, say for the expensive jewelry, is sufficiently high it would initially be shown, at least in row 210, for the first category, and in the appropriate row, say for a ‘cloth and accessories’ category. However, if the product is not of the chosen category it would be removed from the display regardless of fit. So if chosen category, in our example 11, is furniture the jewelry advertisement would disappear, since it is not classified in the furniture category. However, were a ‘cloth and accessories’ category chose, then the jewelry item would be shown (provided its fitness allows it) both in the row for the main category as in one of the rows for its subcategories (say in category a jewelry).

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. For example, steps 420 and 422 may be executed, at least partially, in parallel. Moreover, a given step may not have finished completely before a next step is started.

A method according to the invention may be executed using software, which comprises instructions for causing a processor system to perform method 400. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention.

An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It is noted that fitness may be determined by a matching, e.g. ranking, an advertisement with a user profile. The user profile may in fact comprise category preferences. For example, a sports category may be ranked higher than say a crocheting category. Initially, a category preference may suppress all advertisements of a particular second category from appearing in the first group, as they would have a low fitness. However, as categories are chosen, say a user select an ‘arts and crafts’ category, the relative rank of crocheting related advertisements may be high enough to appear in the first group.

Although, in principle, all advertisements in the first group could be selected from the same second category, it is advantageous if some diversity is present. For example, in a preferred embodiment, the first group contains advertisements selected from at least two second categories.

It furthermore noted that matching and selecting for fitness, though considered very advantageous is not necessary. An improvement over conventional interfaces may be obtained without it. For example, displaying advertisements in multiple rows and allowing selecting of categories together with displaying of advertisements improves the efficiency with which relevant advertisements are presented to the user. The invention is suitable for repeated application; after a category has been selected, again multiple categories may be shown in the same manner, e.g., in rows. In this case the selection may be a random selection, or a selection of the most recent advertisements, etc.

One different way of category navigation uses pull down menus. To advance to a next level of sub categories, e.g., to select a sub-category from a main category, at least two clicks are required: one to activate the pull-down menu, and one to select a category. However, the invention may need only one click since category selection options and advertisement selection options are integrated in a display.

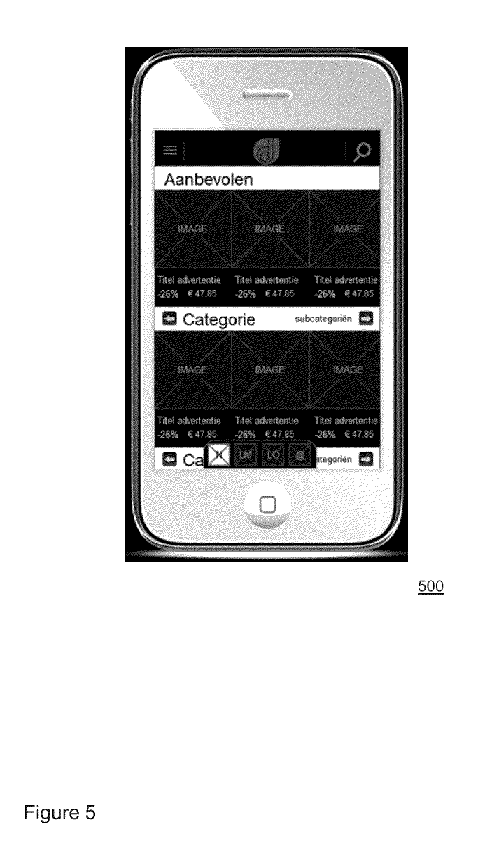

FIG. 5 shows a screenshot of an electronic device using the method.

Shown is a row labeled ‘Aanbevolen’ (recommended), this rows contains advertisements selected from the larger set of advertisements. Below are rows labeled ‘categorie’ (category). These show advertisements in the particular category.

At the bottom of the screen are quick modifiers. For example, by selecting the button labeled ‘N’, the advertisements are restricted to those ‘near’ the current location. Those buttons are provided for a temporary change in the user profile, adding a requirement that the shown advertisement relate to a nearby geographical location, e.g., within a certain radius. For this purpose the electronic device could be equipped with location determination device, say a GPS receiver.

An advertisements profile may comprise a ‘weight’ parameter. The weight parameter always contributes to fitness in addition to contributions dependent upon a match between the advertisements profile and a user profile. In this way, the likelihood that advertisement is shown can be influenced, from outside the electronic device.

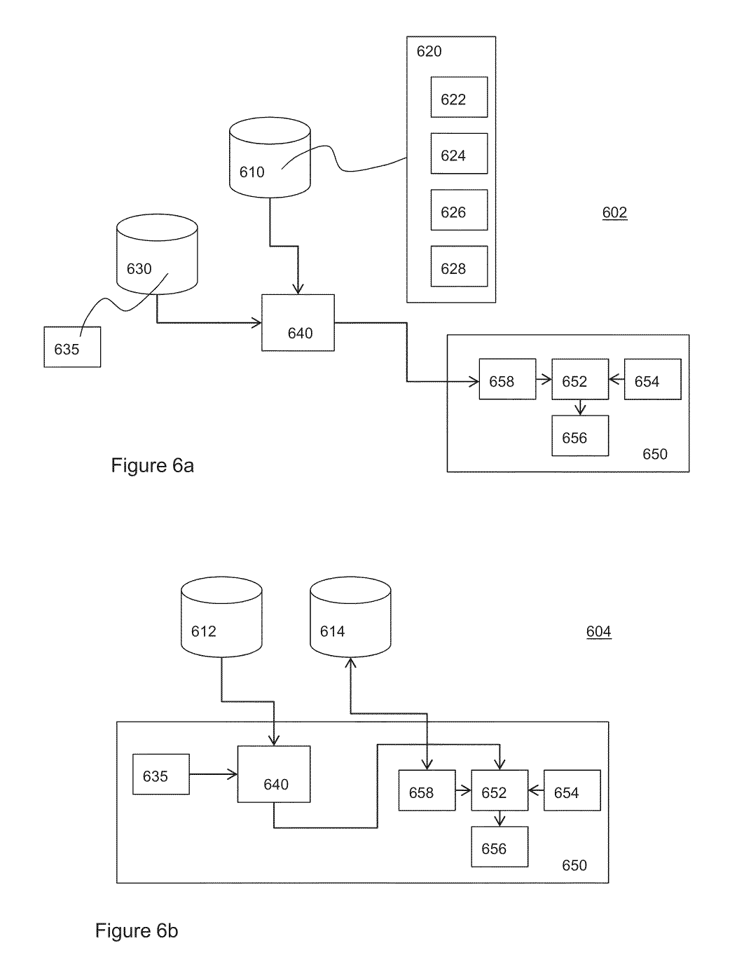

FIG. 6a shows a first advertisement display system 602.

The figure shows an advertisement database 610. The advertisement database 610 comprises a collection of records for storing a set of advertisements. A typical record may be organized as advertisement record 620. Advertisement record 620 comprises a classification 622 of the advertisement, e.g. a category from classification system such as system 100. Preferably, the classification 622 is an end-category, having itself no child categories. Record 620 further comprises an advertisement profile 624. The advertisement profile 624 comprises desired or required features for the user to which the advertisement if to be shown. For example, advertisement profile 624 may comprise a geographical area in which the user is preferred to be when watching the advertisement. Record 620 comprise the advertisement content 626. The content may be a picture, a video, a text etc or any combination thereof. Record 620 may comprise other data 628 for example pricing or discount information.

System 602 comprises a matcher 640 which has access to advertisement database 610. Matcher 640 also has access to a user profile database 630. The user profile database 630 comprises user profiles, such as user profile 635. Matcher 640 matches advertisement against profile. Advertisements having a high fit for a particular user and are in categories needed for display on a mobile phone 650 of the particular user are forwarded to the mobile phone. A selector 652 receives the advertisements along with fitness information and constructs a view wherein advertisements of the first and multiple second categories are shown together, say as in step 450. Selector 652 displays the result on display 656. A user input device 654, say a touch screen or a keyboard, is connected to selector 652 to select a category. Mobile phone 650 further comprises a receiver 658 configured to receive the advertisements. Receiver 658 is further configured to receive the fitness information from matcher 640. Selector 652 is configured to receive from receiver 658 the fitness information and is configured to combine it with classification data to select the advertisements for display using a method according to the invention.

FIG. 6b shows a second advertisement display system 604. System 604 shares most of the functionality with system 602. However, the database 610 is (at least functionally) split into two parts: an advertisement profile database 612 and an advertisement content database 614. Profile database 630 is omitted. A user profile 635 is present on mobile phone 650. Mobile phone 650 comprises a matcher 640. Advertisements profiles are downloaded to phone 650 from profile database 612. Matcher 640 determines which advertisements have high fit; next the advertisements needed for displaying are downloaded from database 614. Mobile phone 650 also comprises a receiver 652 for receiving advertisements, but receiver 652 is not needed to receive fitness information since that information is obtained from matcher 640. Note that matcher 640 could make use of receiver 658 or an alternative source to receive advertisement profiles.

Typically, the electronic device, such as device 650 comprises a microprocessor (not shown) which executes appropriate software stored at the device. For example, the software may have been downloaded and stored in a corresponding memory, e.g. RAM (not shown).

Several new improvements are possible using the new technology. For example, the advertisement distribution system, possibly even in the electronic equipment, say mobile phone 650, could contain a discount calculator. The discount calculator is configured to calculate a discount associated with a particular advertisement. For example, the discount for an advertisement could be dependent on the fitness (match between profiles, advertiser pay for better targeting in part with higher discounts) and the size of the user profile (larger user profiles could be encouraged with larger discounts). A discount could be expressed as a price reduction percentage. The advertisement distribution system may comprise an advertisement upload device configured to receive advertisements, and store them in database 650, or databases 612 and 614.

In an embodiment, the discount calculator computes a profile completeness value representing the number of user profile items obtained for that user. The profile completeness value is preferably expressed as a quotient, say as a percentage, of the total number of user profile items that are available. For example, the percentage could be the percentage of questions answered by a user. Advantageously, the discount calculator is configured to compute the discount in dependence on the profile completeness, a higher profile completeness resulting in a higher discount. This has the advance that user have an incentive to compute their profiles. At the same time a better user profile allows better user targeting, giving sellers the incentive to offer the higher discounts. In a simple implementation computing a discount may comprise, multiplying a base discount with the profile completeness value, the latter being expressed as a ratio between user profile items, and total available user profile items. The base discount may be computed by matching user profile and advertisement profile, and the like.

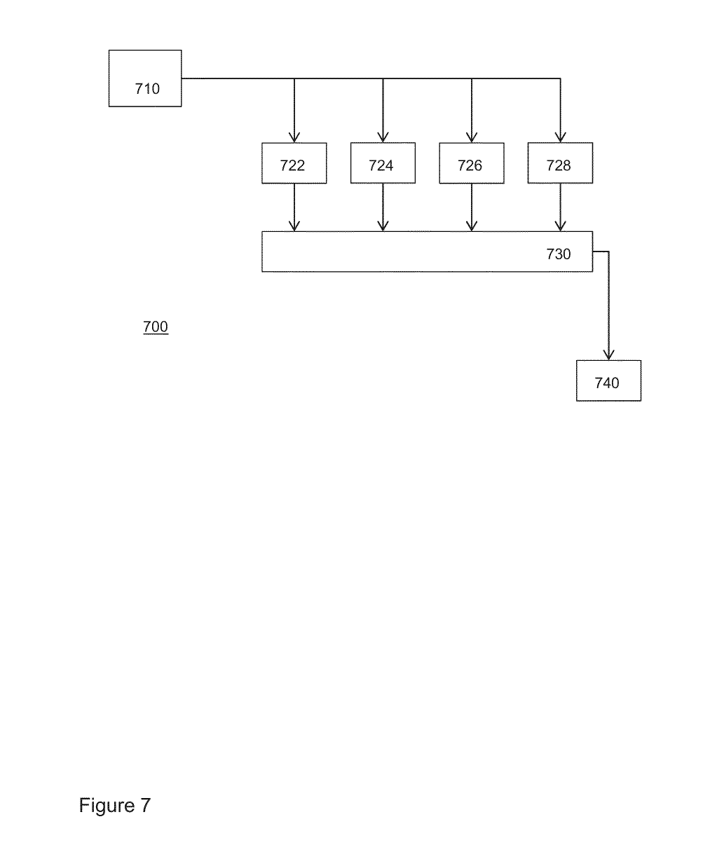

FIG. 7 illustrates in a block diagram a more elaborate matching procedure, that may be used to determine the fitness of an advertisement, e.g., in matcher 640, or in matching step 420.

Step 710 is a filter for pre-filtering the advertisements eligible for this user, and which may receive a fitness. Advertisements which do not pass the filter will not receive a fitness, and will in principle not be selected by the selectors. For example, the filter 710 may filter on the running time of the advertisement. If the advertisement is no longer current it should not be shown. For example, the filter 710 may filter on the budget of the advertiser (e.g. the seller). For example, the filter 710 may filter on the geographic location of the user. Also a user profile may include strict filtering requirements. For example, a user profile may contain an age below an age limit; accordingly advertisements are filtered out, which require an age above the age limit.

The advertisements that pass the initial filtering in 710 are assessed by one or more modules. FIG. 7 shows 4 of such modules: modules 722, 724, 726 and 728. These particular 4 modules have been shown in practice to give good results. However, more or fewer modules are possible. In particular any one of the shown modules may be omitted.

FIG. 7 shows a matching coefficient module 722 configured to match advertisements that passed filter 710 with a user profile. Matching coefficient module 722 may be configured to represent the matching as a matching coefficient indicating the portion of advertisements items out of the total number of advertisements items that match a user profile item.

FIG. 7 shows a behavioral module 724. Behavioral module 724 is configured to determine a user profile based on profiling previous behavior of the user. For example, a score per category may be kept to indicate how often a user accessed that category, e.g. by ‘clicking’ on the category. The match between a profiled user profile and an advertisement profile is represented in a value. Preferably, this value is a ‘multiplier’ for multiplying with matching coefficient.

FIG. 7 shows a target group size module 726 configured to estimate the size of the target group of the advertisement, and to translate this into a value. A larger estimated target group contributes to fitness of an advertisement. The size may be represented as a multiplier, e.g., using a look-up table. The estimated target group may be represented as a percentage of a total population.

FIG. 7 shows a time module 728 configured to determine how often a user has seen a particular advertisement. An advertisement that has not been seen, or at least not often, contributes to a high fitness. Preferably, this value is computed at night; this reduces overhead.

FIG. 7 shows an integrator 730 configured to combine the values obtained by the modules, e.g., modules 722, 724, 726 and 728, to determine a single fitness of a particular advertisement for a particular user. One particular advantageous way of obtaining a fitness it to compute the matching coefficient as a base score, and multiply the scores of the other modules with it. For this purpose, modules different than matcher 722, may produce a value close to 1, preferably, between 0 and 2, more preferably between 0.5 and 1.5.

It is noted that matcher 700 could be made without matching to a user profile, i.e., omitting module 722. Also modules 724, 726, 728 may be omitted, keeping only module 722.

FIG. 7 shows a selector 740, such as selector 652. Selector 740 receives the fitness of integrator 730 and ranks the advertisements. It is advantageous for layouting if selector 740 selects a fixed number of the highest ranking advertisements, say 9.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method (400) for selecting and displaying on an electronic device (500, 650) categorized advertisements (1.1, 1.2, . . . , 113.3), the categorization (100) being hierarchical and comprising a first category (1) and a set of second categories (11, 12, 13) contained in the first category, each advertisement of a set of advertisements classified in the first category is also classified in one of the second categories, the method comprising
selecting (430) from the set of advertisements classified in the first category a first group (210) of general advertisements,
selecting (440) from the advertisement being classified in a specific one of the second categories a second group of specific advertisements (220), and
displaying (450, 200, 300) simultaneously at least part of the first group of general advertisements and at least part of the second group of specific advertisements.

2. A method as in claim 1, further comprising
matching (420) advertisements of the set of advertisements with a user profile to determine a fitness, and wherein
the selecting (430) from the set of advertisements classified in the first category comprises selecting (430) from the set of advertisements classified in the first category the advertisements having a high fitness to obtain the first group (210) of general advertisements, and wherein
the selecting (440) from the advertisement being classified in a specific one of the second categories comprises selecting (440) from the advertisement being classified in a specific one of the second categories comprises the advertisements having a high fitness to obtain a second group of specific advertisements (220).

3. A method as in claim 1, further comprising
for each further one (442) of the second categories, selecting from the advertisement being classified in the further one of the second categories the advertisements having a high fitness to obtain a further second group of specific advertisements (230, 240), and
displaying each of the further second group of specific advertisements simultaneously in a display region at least accessible through display scrolling.

4. A method as in claim 1, wherein different first or second categories are individually scrollable to display more advertisement of the category.

5. A method as in claim 1, wherein the first group of general advertisements is displayed in a row aligned with a side of the display.

6. A method as in claim 5, wherein the second group of specific advertisements and/or further second groups of specific advertisements is displayed in a row horizontally aligned with the side of the display.

7. A method as in claim 1, the categorization further comprising a set of third categories (111, 112, 113) contained in a chosen second category, each advertisement of the set of advertisements classified in the chosen second category (11) being classified in one of the third categories, the method comprising
receiving (460) a user choice for said chosen second category, and thereupon
ceasing to display the first group of general advertisements,
ceasing to display any second group of advertisements and further second group for all non-chosen ones of the second categories,
selecting from the advertisement being classified in a specific one of the third categories having a high fitness to obtain a third group of specific advertisements, and
displaying simultaneously at least part of the second group of specific advertisements corresponding the chosen second category and at least part of the third group of specific advertisements.

8. Electronic device (650, 500) for selecting and displaying categorized advertisements, comprising
a memory configured to store a categorization, the categorization being hierarchical and comprising a first category and a set of second categories contained in the first category,
a receiver for receiving a set of advertisements, each advertisement of the set of advertisements classified in the first category is also classified in one of the second categories,
a selector configured to
select from the set of advertisements classified in the first category a first group of general advertisements, and
select from the advertisement being classified in a specific one of the second categories a second group of specific advertisements, and
a display configured to display simultaneously at least part of the first group of general advertisements and at least part of the second group of specific advertisements.

9. Electronic device as in claim 8, wherein each advertisement has a fitness, the selector being further configured to
select from the set of advertisements classified in the first category the advertisements having a high fitness to obtain the first group of general advertisements, and
select from the advertisement being classified in a specific one of the second categories the advertisements having a high fitness to obtain the second group of specific advertisements.

10. Electronic device as in claim 8, comprising a matching module configured to match advertisements of the set of advertisements with a user profile to determine a fitness.

11. A computer program comprising computer program code means adapted to perform all the steps of claim 1 when the computer program is run on a computer.

12. A computer program as claimed in claim 11 embodied on a computer readable medium.
